(19) United States
(12) Patent Application Publication
(10) Pub. No.: US 2020/0127320 A1
(43) Pub. Date: Apr. 23, 2020

(54) LITHIUM METAL BATTERY

(71) Applicant: SZ DJI TECHNOLOGY CO., LTD., Shenzhen (CN)

(72) Inventors: Bogao XU, Shenzhen (CN); Tao ZHAO, Shenzhen (CN)

(21) Appl. No.: 16/721,130

(22) Filed: Dec. 19, 2019

Related U.S. Application Data
(63) Continuation of application No. PCT/CN2017/100918, filed on Sep. 7, 2017.

(51) Int. Cl. H01M 10/052; H01M 4/38; H01M 10/0587; H01M 10/04

(52) U.S. Cl. CPC H01M 10/052; H01M 10/0422; H01M 10/0587; H01M 4/382

(57) ABSTRACT

Lithium metal batteries are provided. A lithium metal battery includes a case being a cylinder with an opening at one end; a battery cover configured to cover the opening of the case, the case and the battery cover jointly forming a closed space; a support column in the case; and a battery winding core wound around the support column and received into the closed space. The battery winding core includes a positive electrode, a negative electrode containing lithium, and an electrolyte between the negative electrode and the positive electrode. The support column is a hard support column and is coaxially disposed in the case.

### CROSS-REFERENCE TO RELATED APPLICATION

This application is a continuation of International Application No. PCT/CN2017/100918, filed on Sep. 7, 2017, the entire content of which is incorporated herein by reference.

### TECHNICAL FIELD

The present disclosure relates to the field of battery technology and, more particularly, to a lithium metal battery.

### BACKGROUND

With the wide applications of automatic devices such as unmanned aerial vehicles, the demand for high-performance and small-size rechargeable batteries is increasing. Lithium metal batteries use lithium metal, lithium alloy and the like as the electrode materials of the batteries, which have higher energy density, thus the lithium metal batteries have wider applications.

Currently, the lithium metal batteries are fabricated into square and soft packs. Small amount of lithium metal may precipitate and deposit in the lithium metal batteries at each cycle, which may cause the lithium metal batteries to swell, thereby affecting the cycling performance of the lithium metal batteries. In order to inhibit the swelling of the lithium metal battery, two aluminum plates are disposed on two sides of outer surfaces of the lithium metal battery, and the lithium metal battery is sandwiched between two aluminum plates to prevent the lithium metal battery from swelling and deforming using the pressure from the aluminum plates.

However, the lithium metal battery requires two additional aluminum plates, and the weight and volume of the plates theirselves are relatively large, thus the overall energy density of the lithium metal battery is greatly reduced.

### SUMMARY

In accordance with various embodiments of the present disclosure, a lithium metal battery is provided. The lithium metal battery includes a case being a cylinder with an opening at one end; a battery cover configured to cover the opening of the case, the case and the battery cover jointly forming a closed space; a support column in the case; and a battery winding core wound around the support column and received into the closed space. The battery winding core includes a positive electrode, a negative electrode containing lithium, and an electrolyte between the negative electrode and the positive electrode. The support column is a hard support column and is coaxially disposed in the case.

In accordance with various embodiments of the present disclosure, another lithium metal battery is provided. The lithium metal battery includes a case, a support column in the case, and a battery winding core wound between the case and the support column. The case is a cylinder with an opening at one end. The battery winding core includes a positive electrode, a negative electrode containing lithium, and an electrolyte between the negative electrode and the positive electrode. The case and the support column jointly form a space for restraining the battery winding core.

### BRIEF DESCRIPTION OF THE DRAWINGS

In order to more clearly illustrate technical solutions in the embodiments of the present disclosure, drawings required for describing the embodiments are briefly illustrated hereinafter. Obviously, the following drawings are merely examples for illustrative purposes according to various disclosed embodiments of the present disclosure and are not intended to limit the scope of the present disclosure. Those skilled in the art may obtain other drawings according to the drawings of the present disclosure without any creative efforts.

FIG. 1 illustrates a structural schematic of a lithium metal battery according to various disclosed embodiments of the present disclosure; and

FIG. 2 illustrates a cross-sectional schematic of a lithium metal battery according to various disclosed embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a portion of the embodiments of the present disclosure, but not all embodiments. All other embodiments, based on the embodiments of the present disclosure, obtained by those skilled in the art without creative efforts are within the scope of the present disclosure.

A lithium metal battery is a battery using a lithium metal or a lithium alloy as a negative electrode material and also using a non-aqueous electrolyte solution. The lithium metal battery has a relatively high energy density, so the lithium metal battery may provide electrical energy for mobile electronic devices with small volume and weight. Lithium has a low density (0.54 g/cm³), so lithium may store relatively large amount of energy with relatively low mass, thereby achieving a higher energy density.

The lithium metal battery is a secondary battery which may be repeatedly charged and discharged. When the battery is charged, lithium ions are extracted from a positive electrode and inserted into a negative electrode through the electrolyte transmission; after the charging is completed, the negative electrode is in a lithium-rich state and the positive electrode is in a lithium-depleted state. When the lithium metal battery is discharged, the movement path of lithium ions is opposite to the movement path of lithium ions at the battery charging. In order to maintain charge balance, when lithium ions move between the positive and negative electrodes of the battery through the electrolyte, electrons with the same amount of charges as lithium ions are transferred in a circuit outside of the battery, thereby providing electrical energy to an external circuit.

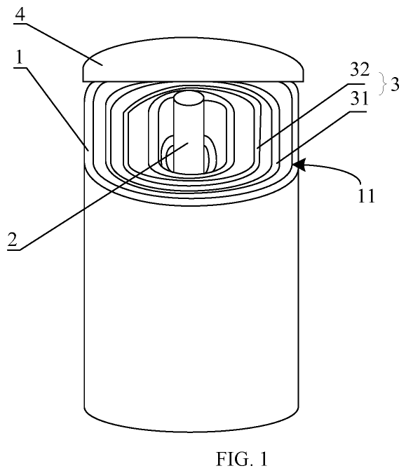

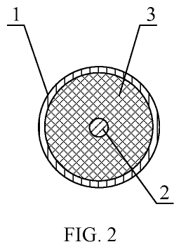

FIG. 1 illustrates a structural schematic of the lithium metal battery according to various disclosed embodiments of the present disclosure. FIG. 2 illustrates a cross-sectional schematic of the lithium metal battery according to various disclosed embodiments of the present disclosure. As shown in FIG. 1 and FIG. 2, the lithium metal battery provided in the embodiments of the present disclosure may include a hard case 1, a hard support column 2 inside the hard case 1, and a battery winding core 3 which is wound between the hard case 1 and the support column 2. The case 1 may be a cylinder with an opening 11 at one end. The battery winding core 3 may include a positive electrode 31, a negative electrode 32, and an electrolyte (not shown) between the negative electrode and the positive electrode. The case 1 and the support column 2 may jointly form a space for restraining the battery winding core 3.

For example, the battery winding core 3 in the lithium metal battery may include the positive electrode 31 and the negative electrode 32. The positive electrode 31 and the negative electrode 32 may in the form of electrode sheets. The positive electrode 31 and the negative electrode 32 may be sequentially stacked and also may be wound to form a round battery winding core 3. The electrolyte may be filled in the round battery winding core 3 to form a conducting circuit between the positive electrode 31 and the negative electrode 32 and may participate reactions of the positive electrode 31 or the negative electrode 32 to ensure the normal function of the lithium metal battery.

When implementing the winding the battery winding core 3, the electrode sheet of the positive electrode 31 and the electrode sheet of the negative electrode 32 may be first stacked, and then be wound into the battery winding core 3, or may be stacked and wound at the same time to form the battery winding core. Currently, for an adopted winding process, the positive electrode 31, the negative electrode 32, a separator, a protection tape, a termination tape and the like may be fixed on an equipment, and then the battery winding core 3 may be formed by the equipment unwinding.

The negative electrode 32 of the battery winding core 3 may contain a lithium element. For example, the negative electrode 32 may include a lithium metal and may also include a lithium compound. When the lithium metal battery is charged or discharged, lithium ions may periodically move back and forth between the positive electrode 31 and the negative electrode 32 of the battery, and may perform chemical reaction with the material of the positive electrode 31 or the negative electrode 32 to transfer charges, thereby implementing the transformation between chemical energy and electrical energy. The negative electrode 32 may be used as an energy carrier through the lithium ions, so the negative electrode 32 may have a relatively high reactivity and may implement a relatively high energy density. The energy density of the lithium metal battery may be equal to or greater than 350 Wh/kg.

When the lithium metal battery is charged, active lithium ions may unevenly deposit on the surface of the negative electrode 32 of the battery. Since the potential of inserted lithium is almost close to the potential of metal lithium, the potential of the negative electrode 32 may become negative under conditions such as high rate, low temperature charging and the like, which may cause metal lithium to precipitate on the surface of the negative electrode 32. The continuous deposition of the lithium on the negative electrode 32 may cause the capacity of the lithium metal battery to be decreased, which may seriously affect battery performance; and the lithium on the negative electrode 32 continues to increase, which may cause the risk of swelling and explosion of the lithium metal battery. Therefore, it is necessary to apply a pressing force to the outside of the battery winding core 3 through an external force, and the lithium metal battery may be prevented from swelling by limiting and squeezing the battery winding core 3, thereby affecting the battery performance and ensuring the battery safe usage.

In order to prevent the battery winding core 3 from swelling, the lithium metal battery may further include a support and a fixing structure capable of limiting the battery winding core 3 in a certain space and also limiting the battery winding core 3 from outward swelling. For example, the support and the fixing structure may include the hard case 1 and the hard support column 2. The hard case 1 may be a hollow cylindrical shape and have the opening 11 at one end, so the battery winding core 3 may enter through the opening after being wound into a round roll and may be accommodated in a cylindrical inner cavity of the case 1. In such way, the outer side of the battery winding core 3 may be firmly wrapped by the inner wall of the case 1; and when the battery winding core 3 has a tendency to swell outwardly due to the deposition of lithium on the negative electrode 32, the inner wall of the case 1 may form a restraint on the battery winding core 3, thereby inwardly squeezing the battery winding core 2, which may restrain the battery winding core 3 inside the inner cavity of the case 1 under the inward pressing force. The opening 11 of the case 1 may allow a positive electrode tab and a negative electrode tab of the battery winding core 3 to protrude outwardly, thereby implementing the conduction between the battery winding core 3 and the external.

Since the case 1 and the inner cavity of the case 1 are both cylindrical, the battery winding core 3 accommodated inside the case 1 may also be placed and arranged in a cylindrical shape. After the winding is completed, the battery winding core 3 may also form a shape similar to cylindrical, so the battery winding core 3 may be smoothly placed inside the cylindrical case 1, and the surface of the battery winding core 3 may be firmly attached to the inner wall of the case 1 to firmly wrap and restrain the winding core 3 by the case 1. Meanwhile, the case 1 is cylindrical, and compared with the existing methods using a square case or the sandwiching the battery winding core between two flat aluminum plates, the cylindrical case 1 may have smaller surface area when the volume of the battery winding core is same, so less materials may be required for the case 1. In addition, the circular shape may spread pressure to other portions when under pressure, so the withstanding pressure capacity of the cylindrical case may be greater than the withstanding pressure capacity of the flat aluminum plates or the square case under a same condition. Therefore, for restraining the battery winding cores of the same volume and for a constant required restraining force, the wall thickness of the cylindrical case may also be thinner than the wall thickness of the square case.

In such way, compared with the existing methods using flat aluminum plates to sandwich the battery or using a square case to restrain the battery winding core, the cylindrical case may have a smaller surface area and also a smaller wall thickness. When a same material is used for the case 1, the cylindrical case may also have a smaller mass, so the cylindrical case may have a smaller mass ratio in the entire lithium metal battery, thereby ensuring the lithium metal battery to have a higher energy density.

The battery winding core 3 may swell due to the deposition of the lithium on the negative electrode 32 of the battery during the charging and discharging process. In order to prevent the battery winding core 3 from collapsing inwardly due to the combined action of its own swelling and the inward pressing force from the case 1, which may crush the inner portion of the battery winding core 3, the hard support column 2 may also be disposed inside the case 1. The length of the support column 2 may be equal to or close to the length of the case 1, so an annular cavity for accommodating the battery winding core 3 may be formed inside the case 1. The support column 2 may be used to support the inner portion of the battery winding core 3, thereby preventing the inner portion of the battery winding core 3 from being deformed or even collapsed due to the swelling of the battery winding core 3. For example, the battery winding core 3 may use the support column 2 as an axis when the battery winding core 3 is wound on the support column 2. Since the support column 2 is made of a hard material, the support column 2 may form a reliable support inside the battery winding core 3. When the battery winding core 3 is deformed inwardly due to the internal stress caused by itself swelling, the hard support column 2 may prevent the battery winding core 3 from being deformed and collapsed, thereby ensuring the normal function of the lithium metal battery.

In such way, by disposing the cylindrical case 1 and the support column 2 inside the case 1, the lithium metal battery may use the inner wall of the case 1 and the support column 2 to respectively squeeze and restrain the inner and outer sides of the battery winding core 3. On the one hand, the space of the battery winding core 3 may be limited, so the battery winding core 3 may not expand outwardly to create danger. On the other hand, the inner and outer sides of the battery winding core 3 may be pressed between the inner wall of the case 1 and the support column 2, so when the battery winding core 3 has a tendency to swell outwardly due to the deposition of lithium on the negative electrode 32, the case 1 and the support column 2 may force the inner electrode sheets of the battery winding core 3 to be attached closer by pressing two sides of the battery winding core 3, thereby improving the electrode sheet interface of the lithium metal battery and increasing the performance of the lithium metal battery.

In order to facilitate the winding of the battery winding core 3, the support column 2 and the case 1 may be separated and detachable. When fabricating the lithium metal battery, the battery winding core 3 may be first wound outside of the support column 2; after the winding of the battery winding core 3 is completed, the battery winding core 3 and the support column may then be together placed inside the case for subsequent assembly.

In one embodiment, the support column 2 may be a solid column. When the battery winding core 3 swells due to the lithium deposition, the battery winding core 3 may form a relatively large pressing force to the external. In order to prevent the support column 2 from being deformed or even damaged under the action of the relatively large pressing force, the support column 2 may be a solid column structure with a relatively stable structure and a desirable withstanding press capacity. The solid column has a relatively large cross-sectional area, so after the support column 2 is fabricated with the solid column, the effect of resisting the lateral shearing force and the pressing force may also be desirable, which may effectively prevent the support column 2 from being bent or broken under the pressure of the battery winding core 3.

Optionally, in order to ensure that the inner and outer sides of the battery winding core 3 of the lithium metal battery are pressed and restrained, the battery winding core 3 may be firmly wound on the outer side of the support column 2 along a circumferential direction of the support column 2, and an outmost portion of the battery winding core 3 may be firmly attached to the inner wall of the case 1. In such way, the portion close to the inner side of the battery winding core 3 may be firmly wound around an outer edge of the support column 2 and be well supported by the support column 2; and the outermost portion of the battery winding core 3 may also be pressed by the inner wall of the case 1. When the lithium metal battery generates lithium deposition during the charging and discharging process, the case 1 and the support column 2 may clamp the battery winding core 3 from the inner and outer sides of the battery winding core 3, and apply the pressing force against the swelling deformation to the battery winding core 3, thereby preventing the battering winding core 3 from being swelled and deformed due to the lithium deposition. Furthermore, each electrode sheet inside the battery winding core 3 may be attached firmly under the external pressing force, so the distance between the electrode sheets may be smaller, and the electrode sheet interface of the battery winding core 3 may be effectively improved.

In order to make the support column 2 to effectively support the inner side of the battery winding core 3, the support column 2 and the case 1 may be coaxially disposed. For example, the case 1 is cylindrical, so the support column 2 and the case 1 may be disposed along a same direction, and the support column 2 may be at a cylindrical axis position of the case 1, that is, the distances between the support column 2 and the inner wall of the case 1 along all directions of the circumference of the case 1 may be equal. In such way, after the battery winding core 3 is wound on the outside of the support column 2 layer by layer, the thicknesses of the battery winding core 3 with respect to all directions along the circumference of the support column 2 may be approximately equal, so the cylindrical shape formed by the battery winding core 3 may match the shape of the inner cavity of the case 1, the battery winding core 3 may be smoothly disposed inside the case 1, and the outer side of the battery winding core 3 may be firmly abutted and attached to the inner wall of the case 1. In addition, the support column 2 is at the axial location of the case 1, and the thicknesses of the battery winding core 3 along all directions around the support column 2 may be equal or approximately same, so the support column 2 may provide a desirable support for the battering winding core 3 along all directions.

Furthermore, during the winding process, the battery winding core 3 may be formed by stacking and winding layered electrode sheets, and the size of the electrode sheet along an axial direction of the case may be close to the size of the inner cavity of the case 1. Therefore, in order to make the battery winding core 3 to be pressed and supported at various positions along the axial direction of the case 1, the length of the support column 2 may need to be close to the length of the battery winding core 3 along the axial direction of the case 1, thereby avoiding the length of the battery winding core 3 exceeding the end of the support column 2, which may cause bending, damage and the like of the battery winding core 3 under the pressing action. In order to make the battery winding core 3 to be supported by the support column 2 at various positions along the axial direction of the case 1, and further ensure the support effect of the support column 2 on the battery winding core 3, the length of the support column 2 may match the length of the inner cavity of the case 1.

For example, the length of the support column 2 may be same as the length of the inner cavity of the case 1 or may be slightly shorter than the length of the inner cavity of the case 1. The battery winding core 3 is in the inner cavity of the case 1, so when the length of the support column 2 matches the length of the inner cavity of the case 1, it may be ensured that the support column 2 may support the inner side of the battery winding core 3 regardless of the size of the battery winding core 3 along a length direction of the case 1, thereby preventing the battery winding core 3 from being deformed, or even collapsed or broken under the external pressure or the internal stress due to insufficient support.

The battery winding core 3 may be wound around the support column 2 along the circumferential direction of the support column 2, and the lithium deposition may cause the swelling tendency during the charging and discharging process of the lithium metal battery. Therefore, in order to prevent the battery winding core 3 from being scratched or crushed when being pressed toward the support column 2 under the internal stress of the swelling, sharp edges or other protruding structures should be avoided on the surface of the support column 2. For example, a cross-section of the support column 2 may be circular or elliptical, where the cross section of the support column 2 may be a cross section perpendicular with an axial direction of the support column 2. When the cross section of the support column 2 is circular or elliptical, the sidewall surfaces of the support column 2 may be smooth curved surfaces. Therefore, when the battery winding core 3 and the support column 2 are squeezed with each other, excessive pressure may not be generated on the surface of the support column 2, so the battery winding core 3 may be prevented from being cracked, and the lithium metal battery may be prevented from being damaged, leaked and the like, thereby having desirable safety performance.

In addition, when the cross section of the support column 2 is circular or elliptical, the distances between the support column 2 and the inner wall of the case 1 along all directions of the circumference of the case 1 may be close or equal, and it may ensure that two sides of the battery winding core 3 may be firmly and respectively attached to the support column 2 and the case 1, thereby improving the electrode sheet interface of the battery winding core 3.

In order to enable the support column 2 to provide sufficient supporting capacity and prevent the support column 2 from being deformed or broken due to the internal stress of the battery winding core 3, the support column 2 may be made of a material having sufficient hardness. For example, the support column 2 may be a steel column, an aluminum alloy column, a hard-plastic column and the like. The battery winding core 3 may be sealed from the external through an aluminum plastic film and the like, so the battery winding core 3 may be insulated from the support column 2 or the case 1. That is, metal materials with relatively high hardness and desirable mechanical property, including various types of alloy steels or aluminum alloys, may be selected to fabricate the support column, thereby ensuring the support column 2 to form a desirable support under the internal stress of the battery winding core 3. In addition, the support column 2 may also be made of a hard plastic, which may have relatively high hardness and not easily deformed, including acrylonitrile butadiene styrene (ABS), polyvinyl chloride (PVC) and the like. Furthermore, the materials for fabricating the support column 2 may also be alloys, hard plastics or other commonly used structural materials known to those skilled in the art with sufficient hardness and mechanical performance, which may not be described in detail herein.

The case 1 needs to withstand the deformation and the swelling generated in the battery winding core 3 during the lithium deposition on the negative electrode 32, so the case 1 may also need to be made of a hard material with certain mechanical performance. For example, the case 1 may be made of alloy steel with desirable hardness and toughness. In such way, the case 1 may have a relatively strong resistance to deformation and may suppress the swelling tendency of the battery when the lithium metal battery deforms and swells. Meanwhile, the case 1 may have a desirable toughness, which may improve the ease of use and lifetime of the case 1 and also avoid the damage and fracture of the case 1 due to fragility when the lithium metal battery is bumped or dropped.

The case 1 may occupy a relatively large volume and space in the lithium metal battery. Therefore, in order to reduce the mass of the case 1 and increase the energy density of the battery, the case 1 may be made of a relatively low-density aluminum alloy. In such way, while ensuring that the case 1 may resist the battery swelling, the case 1 may also have a possible small mass to further improve the overall energy density of the lithium metal battery.

As an optional structural implementation manner of the lithium metal battery, the lithium metal battery may include a battery cover 4 which may be configured to cover the opening 11 of the case 1. In such way, the case 1 and the battery cover 4 of the lithium metal battery may jointly form a closed space, which may enclose the battery winding core 3 into such space. Therefore, the battery winding core 3 may be isolated from the external environment, which may effectively avoid moisture, shortage, low capacity of the lithium metal battery, and the like inside the battery winding core 3 due to external impurities or water vapor, thereby improving the environmental adaptability of the lithium metal battery.

The battery cover 4 of the lithium metal battery may be made of a plastic or a metal material. When the battery cover 4 of the lithium metal battery is made of a metal material, the edge of the battery cover 4 or the opening edge of the case may be provided with a curling edge, thereby making the battery cover 4 and the case 1 to form a relatively tight connection with desirable sealing performance.

In order to maintain an electrical contact connection between the external and the lithium metal battery, an opening or a through trench, which is used for a positive electrode tab and a negative electrode tab to protrude outwardly, may be disposed at the battery cover 4. Moreover, a structure capable of implementing electrical conduction may be disposed at the battery cover 4, and the positive electrode 31 and the negative electrode 32 of the battery winding core 3 may be electrically connected to the external through the electrical connection.

Furthermore, it should be noted that, in order to use the lithium element as the battery negative electrode to achieve the relatively high energy density in one embodiment, the negative 32 of the lithium metal battery may include a lithium metal compound or a lithium compound. Compared with the lithium metal battery having graphite as the negative electrode, the lithium metal battery that the negative electrode is mainly composed of the lithium element as the active material may achieve a relatively high energy density due to more direct participations in chemical reactions of the lithium element. For example, the negative electrode 32 of the lithium metal battery may be disposed with the lithium metal in the form of coating and the like, and may directly provide lithium ions for participating in the internal reaction of the battery through the lithium metal, or may also exchange lithium ions through a lithium-containing compound such as lithium-titanate (Li₄Ti₅O₁₂), thereby implementing a normal charging or discharging reaction.

In one embodiment, the negative electrode 32 of the lithium metal battery may be a copper foil coated with lithium metal on the surface of the copper foil. The copper foil may have excellent electrical conductivity, so the copper foil may be used as the main structure of the negative electrode 32 to ensure the excellent electron transfer. In addition, the lithium metal may be directed coated on the surface of the copper coil, so the lithium metal may be used to perform internal reactions of the lithium metal battery to provide energy storage. Compared with the negative electrode which is made of graphite, the mass energy density and the volume energy density of the negative electrode containing the lithium metal may be approximately doubled.

Corresponding to the negative electrode, the positive electrode 31 of the lithium metal battery may also be fabricated with the compound containing lithium. For example, the positive electrode 31 of the lithium metal may be one of the following compounds, including lithium cobaltate (LiCoO₂), nickel cobalt lithium manganate (LiNiₓCo_{y}Mn_{1-x-y}O₂), or lithium manganate (LiMn₂O₄). In addition, the positive electrode 31 of the lithium metal may also be made of other commonly used electrode materials having the sufficient energy density, which may not be described in detail herein.

Furthermore, in order to transport lithium ions between the positive electrode 31 and the negative electrode 32, the electrolyte in the battery winding core 3 may be a liquid electrolyte or a solid electrolyte. Optionally, in order to provide the sufficiently high energy density and avoid the occurrence of electrolyte leakage and the like in the battery winding core 3 of the lithium metal battery, the electrolyte in the battery winding core 3 may be the solid electrolyte. The solid electrolyte may have a relatively high ionic conductivity, so the solid electrolyte may have a high energy density compared with a general liquid electrolyte, which may meet the functional requirements of the battery. At the same time, compared with the liquid electrolyte, the solid electrolyte may also have a certain mechanical strength, which may greatly improve the safety performance of the lithium metal battery and reduce the damage probability of the battery winding core. In addition, the solid electrolyte may also have a long cycle life to improve the stability of the battery.

For example, the solid electrolyte commonly used in the lithium metal battery may mainly include a polymer solid electrolyte or an inorganic solid electrolyte such as an oxide electrolyte or a sulfide electrolyte, and may also be other electrolyte materials known to those skilled in the art.

In one embodiment, the lithium metal battery may include the hard case, the hard support column in the case, and the battery winding core wound between the case and the support column; the case may be the cylinder with the opening at one end; the battery winding core may include the positive electrode, the negative electrode containing lithium, and the electrolyte between the negative electrode and the positive electrode; and the case and the support column may jointly form the space for restraining the battery winding core. In such way, the inner side of the cylindrical case and the support column may be configured to respectively press and restrain two inner and outer sides of the battery winding core, which may limit the space of the battery winding core and avoid the outward swelling of the battery winding core; and the case and the support column may have low masses, which may make the battery to have a higher energy density.

It should be finally noted that the above-mentioned description may merely the embodiment of the present disclosure and may not intended to limit the scope of the present disclosure. Although the present disclosure has been described in detail with reference to the above-mentioned embodiments, those skilled in the art should understand that various modifications of the technical solutions may be made in the present disclosure, or equivalent replacements of some or all of the technical features may be made in the present disclosure. However, the modifications and equivalent replacements made within the spirit and principle of the present disclosure should be included in the scope of the technical solutions of the various claims of the present disclosure.

What is claimed is:

1. A lithium metal battery, comprising:
a case, being a cylinder with an opening at one end;
a battery cover, configured to cover the opening of the case, the case and the battery cover jointly forming a closed space;
a support column, in the case; and
a battery winding core, wound around the support column and received into the closed space, the battery winding core comprising a positive electrode, a negative electrode containing lithium, and an electrolyte between the negative electrode and the positive electrode,
wherein the support column is a hard support column and is coaxially disposed in the case.

2. The battery according to claim 1, wherein:
the battery winding core is firmly wound on an outer side of the support column along a circumferential direction of the support column, and
an outmost portion of the battery winding core is firmly attached to an inner wall of the case.

3. The battery according to claim 1, wherein:
a length of the support column matches a length of an inner cavity of the case.

4. The battery according to claim 1, wherein:
a cross-section of the support column is circular or elliptical.

5. The battery according to claim 4, wherein:
the support column is a steel column, an aluminum alloy column, or a hard plastic column.

6. The battery according to claim 1, wherein:
the case is a hard case, including a steel case or an aluminum alloy case.

7. The battery according to claim 1, wherein:
the negative electrode includes a lithium metal or a lithium compound.

8. The battery according to claim 7, wherein:
the negative electrode is a copper foil coated with the lithium metal on a surface of the copper foil.

9. The battery according to claim 7, wherein:
the positive electrode is one of lithium cobaltate, nickel cobalt lithium manganate, or lithium manganate.

10. The battery according to claim 1, wherein:
the electrolyte is a solid electrolyte.

11. The battery according to claim 1, wherein:
an energy density of the lithium metal battery is equal to or greater than 350 Wh/kg.

12. A lithium metal battery, comprising:
a case, a support column in the case, and a battery winding core wound between the case and the support column, wherein:
the case is a cylinder with an opening at one end;
the battery winding core includes a positive electrode, a negative electrode containing lithium, and an electrolyte between the negative electrode and the positive electrode; and
the case and the support column jointly form a space for restraining the battery winding core.

13. The battery according to claim 12, wherein:
the support column is a hard support column, the hard support column including a solid column.

14. The battery according to claim 12, wherein:
the battery winding core is firmly wound on an outer side of the support column along a circumferential direction of the support column, and
an outmost portion of the battery winding core is firmly attached to an inner wall of the case.

15. The battery according to claim 14, wherein:
the support column and the case are coaxially disposed.

16. The battery according to claim 14, wherein:
a length of the support column matches a length of an inner cavity of the case.

17. The battery according to claim 12, wherein:
a cross-section of the support column is circular or elliptical.

18. The battery according to claim 17, wherein:
the support column is a steel column, an aluminum alloy column, or a hard plastic column.

19. The battery according to claim 12, wherein:
the case is a hard case, including a steel case or an aluminum alloy case.

20. The battery according to claim 12, wherein:
the negative electrode includes a lithium metal or a lithium compound.
